(19) United States
(12) Patent Application Publication
(10) Pub. No.: US 2014/0132993 A1
(43) Pub. Date: May 15, 2014

(54) IMAGE PROCESSING APPARATUS, METHOD OF CONTROLLING THE SAME, AND STORAGE MEDIUM

(71) Applicant: Canon Kabushiki Kaisha, Tokyo (JP)

(72) Inventor: Yoshihisa NOMURA, Yokohama-shi (JP)

(73) Assignee: Canon Kabushiki Kaisha, Tokyo (JP)

(21) Appl. No.: 14/074,998

(22) Filed: Nov. 8, 2013

(30) Foreign Application Priority Data
Nov. 14, 2012 (JP) 2012-250586

(51) Int. Cl. G06K 15/02; G06K 15/12

(52) U.S. Cl. CPC G06K 15/1869; G06K 15/12
USPC 358/3.24

(57) ABSTRACT

An image processing apparatus, an image processing method for controlling it, and a storage medium. The image processing apparatus determines whether or not a line of interest is a black line, and counts, when it is determined that the line of interest is the black line, the number of consecutive black lines. It determines whether or not the line of interest is in a black area in accordance with whether or not the number of consecutive black lines counted in the counting is greater than a predetermined value, and in a case that it is determined that the line of interest is the black line and it is determined that the line of interest is not in the black area, it executes thinning processing for the line of interest.

### BACKGROUND OF THE INVENTION

1. Field of the Invention

The present invention relates to an image processing apparatus, a method of controlling the same, and a storage medium.

2. Description of the Related Art

Amongst image processing apparatuses having a print function, printing of data generated by a computer or the like has become more common. Image processing apparatuses such as laser beam printers receive commands and coded text and graphical information related to printing from a host computer such as a computer or a workstation. The received command information is converted into pixel information by rendering means, and based on image signals generated based on this pixel information an image is formed (printed).

In this image forming, adjustment processing of detecting black lines and adjusting a toner application amount may be performed. This processing is for preventing an occurrence of such things as toner scattering when, upon developing, an amount of toner to adhere is too large and the toner does not completely fix to a sheet.

Specifically, a problem was occurring in that, as shown in FIG. 2, when a straight line is printed in a main scanning direction, toner would scatter backwards from a line 202 printed on a sheet 201 with respect to a conveyance direction of a sheet and spoil the image. As shown in FIG. 3, when a fixing unit 301, internally carrying a high temperature heater, passes the sheet 201, water within the sheet becomes water vapor 302 from being suddenly heated up, and flies out from the paper. It is known that when, in these circumstances, a toner 303 is in a thin, tall, embankment-like state, the toner succumbs to a force of the water vapor 302 of the sheet 201 and is blown backwards with respect to the conveyance direction (parallel to but opposite of the sub-scanning direction). Hereinafter, a phenomenon of toner being scattered backwards with respect to the conveyance direction of a line image, which is a straight line in the main scanning direction, and spoiling the image will be referred to as “tailing blur phenomenon”. Note, the conveyance direction of the sheet 201 will be considered to be parallel to, but opposite of, the sub-scanning direction and a direction orthogonal to that direction will be considered to be the main scanning direction. Also, a part of the sheet 201 that the fixing unit 301 reaches first is referred to as an upstream area and a part that the fixing unit 301 reaches later is referred to as a downstream area.

As a counter-measure to the “tailing blur phenomenon”, a method of reducing the toner application amount has come to be employed conventionally. Specifically, it is determined whether or not there is a black area based on image data, and thinning processing is performed on the image data using that determination result. The determination as to whether or not there is a black area is made by counting a number of consecutive black lines in the sub-scanning direction, and determining that a black area has been entered when that number is greater than or equal to a threshold. Then, the following downstream area in the sub-scanning direction (the area to be thereafter fixed) is treated as a black area. Also, a number of consecutive white lines in the sub-scanning direction is counted and when this number of consecutive white lines becomes greater than or equal to a threshold, it is determined that the black area has been exited. After exiting, the subsequent downstream area in the sub-scanning direction is treated as non-black area.

The thinning processing unit looks at a state of a flag indicating whether or not a black area has been entered, and controls so as to perform thinning processing on a black line. Note, it is known that the frequency with which the “tailing blur phenomenon” occurs depends on environmental conditions such as a humidity level or a temperature of an environment in which the image processing apparatus is set up. Also, it is known that there is also a difference in occurrence frequency depending upon the type of material used in the printing sheet, for example, as there are various materials used in sheets.

Because, in a case where the aforementioned adjustment processing of toner application amount is performed in hardware, a reference window for acquiring vicinity pixel information is set, and SRAM is used as a line buffer for the window, there exists a problem in that the scale of the electric circuit increases, causing cost and electric power consumption to increase. Also, in a case where the processing is performed in software, because of an increase in load on the CPU due to work memory and calculation, there exists a problem that performance suffers.

Meanwhile, an image processing apparatus that decreases memory capacity by only storing information necessary for image calculation out of vicinity pixel information, and for example, can detect a black streak in an original, as well as a black streak detection method have been proposed (for example, see Japanese Patent Laid-Open No. 2001-157046). In this invention, run lengths of white pixels and black pixels are each calculated per scanning line to be used for detecting black streaks, and with these white and black pixel run lengths, positions at which white pixels change to black pixels on the scanning line are calculated. Then, black streak position candidates acquired from a previously read scanning line are stored. If a position in a line being currently processed at which there is a change from white pixels to black pixels matches with a black streak position candidate, the black streak position candidate is kept, and if there is no match the candidate is discarded. Black pixels are detected to be at a black streak position based on black streak position candidates that are not discarded, having performed processing for a particular number of scanning lines. In this way, a technique is recited in which black streaks are detected while reducing memory capacity by not using a line buffer and rather storing only coordinate positions.

The above described method is valid in a case where the black streaks only exist in a few locations on the main scanning line. However, in a case where the method of storing coordinate information is adopted to reduce toner application amount, because vicinity information is needed for each pixel, there was a problem in that the memory capacity needed for the coordinate information would increase beyond the line buffer capacity.

### SUMMARY OF THE INVENTION

An aspect of the present invention is to eliminate the above-mentioned problems with the conventional techniques.

A feature of the present invention is to provide a technique in which it is possible to realize processing for suppressing occurrence of the tailing blur phenomenon by thinning black pixels in image data while using less memory capacity.

According to an aspect of the present invention, there is provided an image processing apparatus comprising a first determination unit configured to determine whether or not a line of interest is a black line, a counting unit configured to count, when the first determination unit determines that the line of interest is the black line, a number of consecutive black lines, a second determination unit configured to determine whether or not the line of interest is in a black area in accordance with whether or not the number of consecutive black lines counted by the counting unit is greater than a predetermined value, and an image processing unit configured to, in a case that the first determination unit determines that the line of interest is the black line and the second determination unit determines that the line of interest is not in the black area, execute thinning processing for the line of interest.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a configuration diagram of a printing system according to some embodiments.

FIG. 2 is a view for explaining a common tailing blur phenomenon.

FIG. 3 is a simplified view for explaining a mechanism by which the common tailing blur phenomenon occurs in an electrophographic method printer.

FIG. 4 is a block diagram for showing a configuration of an image conversion unit according to a first embodiment.

FIG. 5 is a flowchart for describing an example of processing by a line width counter unit according to the first embodiment.

FIG. 6 is a flowchart for describing processing by a black area determination unit according to the first embodiment.

FIG. 7 is a flowchart for describing processing by a thinning processing unit according to the first embodiment.

FIG. 8A, FIG. 8B and FIG. 8C are views for explaining an outline of thinning processing by the thinning processing unit according to the first embodiment.

FIG. 9 is a view for showing an example of thinning setting information corresponding to black line widths for each black area state according to a first embodiment.

FIG. 10 is a view for showing an example of a thinning pattern according to some embodiments.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention. Note, in the present embodiment, explanation will be given for a case adopted to a laser beam printer, but the present invention is not limited to this, and so long as it keeps within the spirit of the present invention, adoptions may be made to an electrophographic image processing apparatus such as another kind of printer or a facsimile apparatus, for example. Also, explanation will be given for a monochrome printer, but adoption may be made to a color printer as well.

Firstly, explanation will be given for an outline of the present embodiment.

In the present embodiment, a number of consecutive black lines in a sub-scanning direction is counted, and when the number of consecutive black lines is greater than or equal to a first threshold, it is determined that a black area has been entered, and a flag (BkAreaFlag) indicating the black area is turned on. Then, the subsequent downstream area in the sub-scanning direction (the area to be thereafter fixed) is treated as a black area. Similarly, a number of consecutive white lines in a sub-scanning direction is counted, and when the number of consecutive white lines is greater than or equal to a second threshold, it is determined that the black area has been exited, and the flag (BkAreaFlag) indicating the black area is turned off. Then, the subsequent downstream area in the sub-scanning direction is treated as non-black area. Also, thinning processing on black lines is controlled based on a state of the flag indicating the black area (BkAreaFlag). Here, counters for the aforementioned numbers of consecutive black and white lines increment the count values, that were calculated for the upstream area one line previous in the sub-scanning direction (previously fixed area) and stored in a storage unit, by a number of black or white lines currently being processed, or the counters are cleared. Also, the result is once again stored in the storage unit.

Note, in the present embodiment, the line determination for determining whether or not there is a black area (black line/white line/other) is performed using a window of 9 pixels×31 lines at a resolution of 600 dpi. Here, a center of the window is made to be a pixel of interest (a fifth pixel from the left of the window, and a sixteenth line from a top of the window), a line including the pixel of interest is made to be a line of interest, and processing is performed in raster format in the main scanning direction on each pixel. However, the size of the window is something for determining whether or not there is a black area and is not limited to the above described size, and processing can also be performed with a larger window, for example.

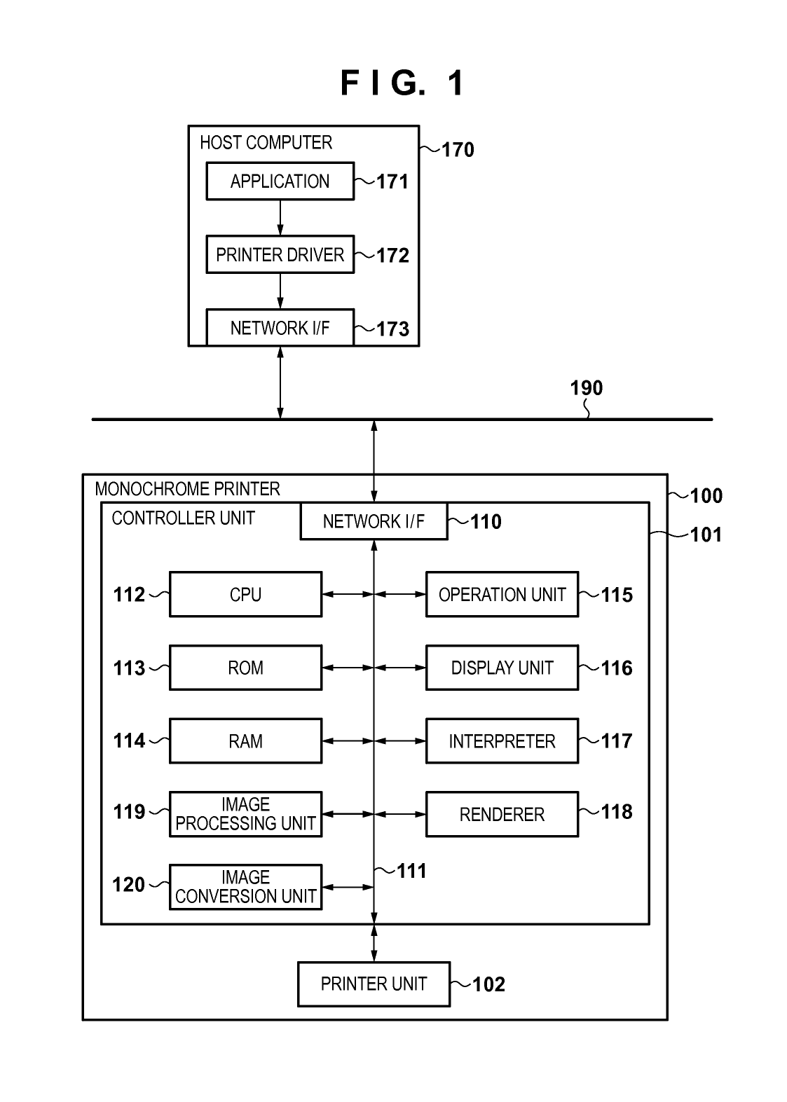

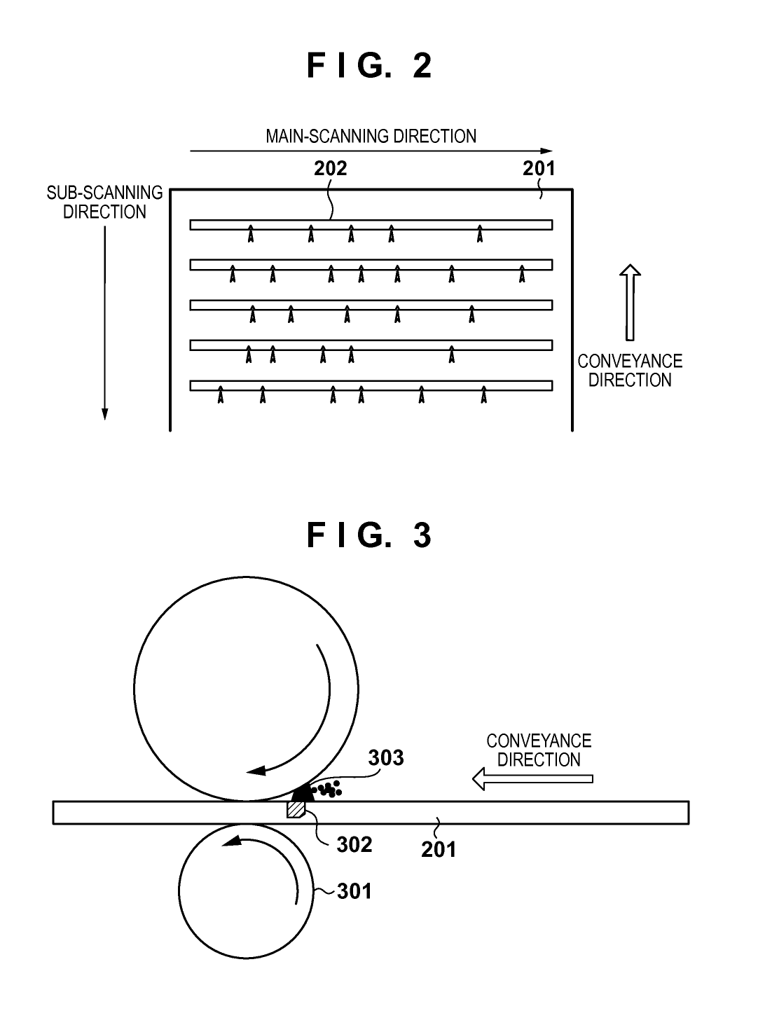

FIG. 1 is a configuration diagram of a printing system according to a first embodiment.

In this printing system, a host computer 170 and a monochrome printer 100 are connected to each other via a network 190. Here the host computer 170 transmits a drawing command to the monochrome printer 100, and the monochrome printer 100, having received this, converts the drawing command into printable image data and prints it onto a surface of a sheet.

The host computer 170 comprises an application 171, a printer driver 172 and a network I/F 173. The application 171 is an application for operating the host computer 170 and the application is used to generate such things as a page layout document, a word processing document or a graphic document. The printer driver 172 generates drawing commands based on document data generated by the application 171. The drawing commands generated by the printer driver 172 may be of a printer definition language such as PDL (page description language). Also, normally, in the drawing commands, drawing instructions for data such as text, graphics or images are included. The drawing commands thus generated are transmitted from the network I/F 173 via the network 190 to the monochrome printer 100.

Next, explanation will be given for the monochrome printer 100.

The monochrome printer 100 is equipped with a controller unit 101 and a printer unit 102. In the controller unit 101, various modules such as a CPU 112 are connected via a system bus 111. A RAM 114 loads program data stored in a ROM 113 and stores it temporarily. The CPU 112 outputs commands to various modules in accordance with programs loaded into the RAM 114, causing the printer 102 to operate. Also, data, and the like, that is generated when each of the modules executes commands is stored temporarily in the RAM 114. A network I/F 110 controls an interface with the network 190. The network I/F 110 receives drawing commands from other devices via the network 190 based on a communication protocol such as Ethernet (registered trademark), and also transmits device information of the monochrome printer 100 (jam information, paper size information, etc.) to the host computer 170.

A display unit 116 displays instructions to a user and UI (User Interface) screens indicating states of the printer 102. An operation unit 115 is a user interface for receiving input from the user.

An interpreter 117 generates intermediate language data by interpreting drawing commands received via the network I/F 110. A renderer 118 generates raster image data from generated intermediate language data. An image processing unit 119 performs image processing on the generated raster image data such as gamma correction processing or pseudo halftone processing with color conversion processing or with a look-up table. An image conversion unit 120 performs thinning processing on input image data to suppress the tailing blur phenomenon, and converts data into image data of a format outputtable by the printer unit 102. Detailed explanation of the image conversion unit 120 will be made later.

The printer unit 102 connected to the controller unit 101 forms an image (prints) on a surface of a sheet using toner based on outputtable image data converted by the image conversion unit 120.

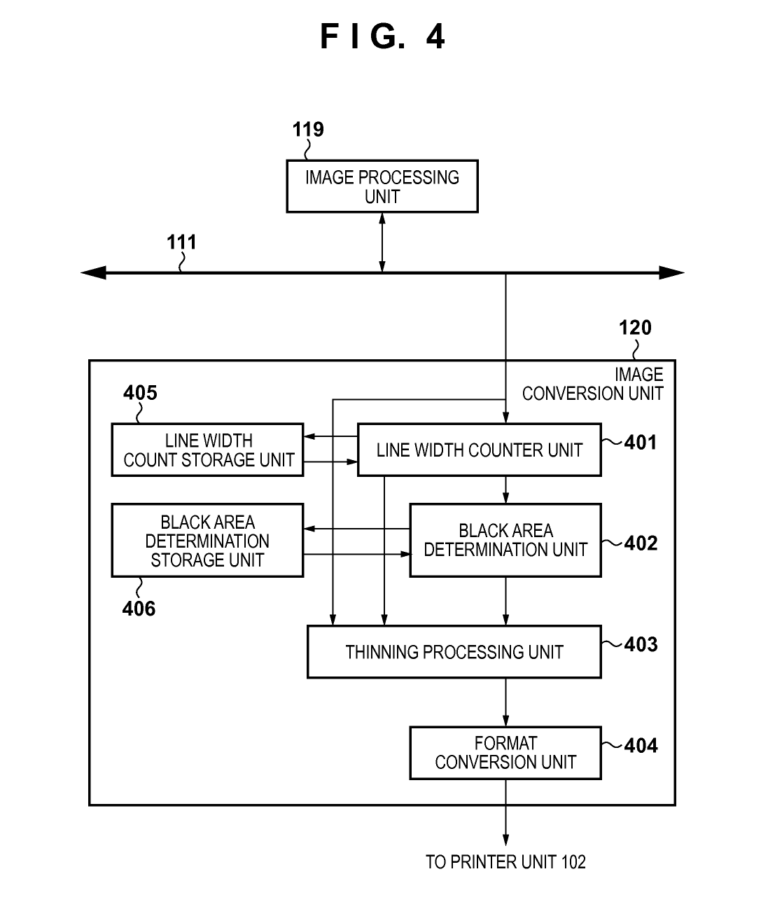

FIG. 4 is a block diagram for showing a configuration of the image conversion unit 120 according to the first embodiment.

The image conversion unit 120 inputs image data on which image processing was performed by the image processing unit 119, and outputs to the printer unit 102 having converted the data into image data of a format that the printer unit 102 can accept, while performing thinning processing.

The image conversion unit 120 comprises a line width counter unit 401, a black area determination unit 402, a thinning processing unit 403, a format conversion unit 404, a line width count storage unit 405 and a black area determination storage unit 406. The image conversion unit 120 updates information of the line width count storage unit 405 and the black area determination storage unit 406 in accordance with processing by the line width counter unit 401 and the black area determination unit 402.

Note, in the first embodiment, blocks may be configured in hardware or processing functions may be realized by the CPU 112 executing a program loaded from the ROM 113 into the RAM 114. In such a case, the program is assumed to support functions for reading image data from the RAM 114 and writing to the RAM 114.

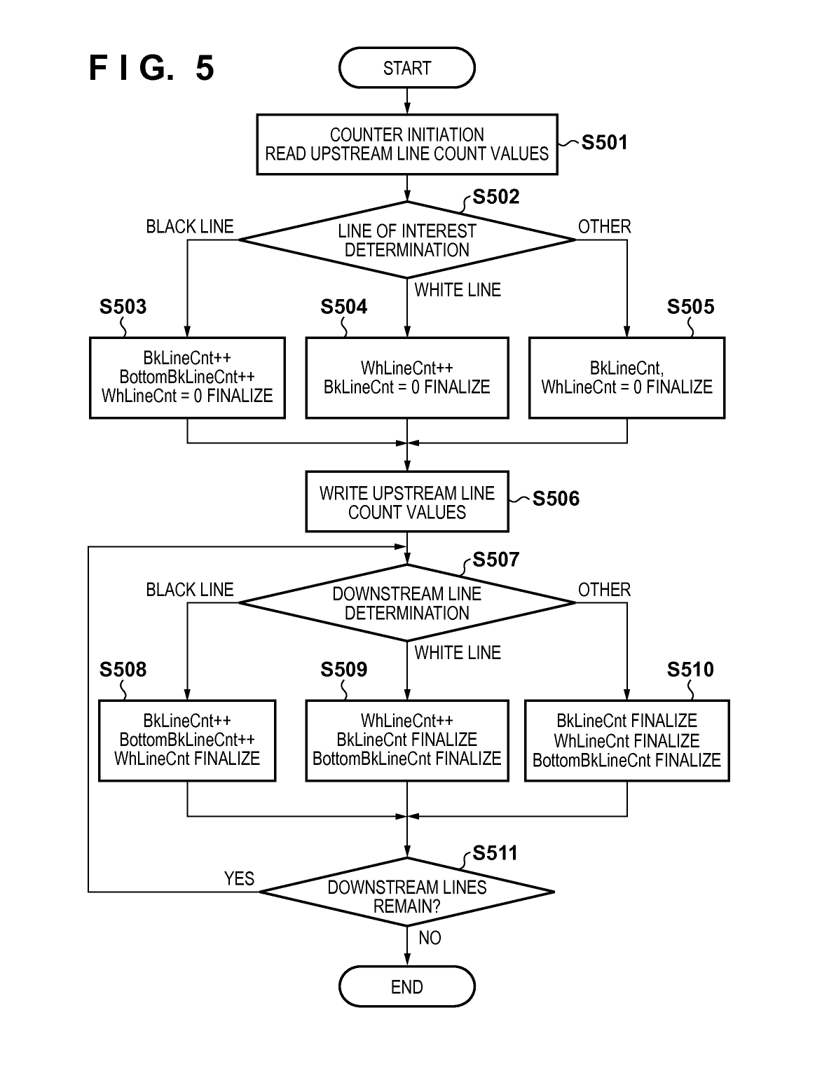

The line width counter unit 401, for the upstream area in the sub-scanning direction, reads the line width count values stored when processing one line previous from the line width count storage unit 405 and makes these the black and white count values. The image conversion unit 120 acquires an oblong rectangle shaped window image (for example, nine pixels in the main scanning direction and thirty one lines in the sub-scanning direction at 600 dpi) from downstream area image data in the sub-scanning direction including a line of interest received from the image processing unit 119. Then, it determines a state (black line or white line or other) of each line of the oblong rectangle shape window image from a number of black pixels or a percentage for each line. Note, explanation of a line buffer, or the like, for generating the oblong rectangle shape window image is omitted. Next, based on the determination result of each line, numbers of consecutive black and white lines are counted in the window image. Furthermore, after processing the line of interest, the count values counted by the line width counter unit 401 are written to the line width count storage unit 405. Detailed processing of the line width counter unit 401 will be explained later with reference to the flowchart of FIG. 5.

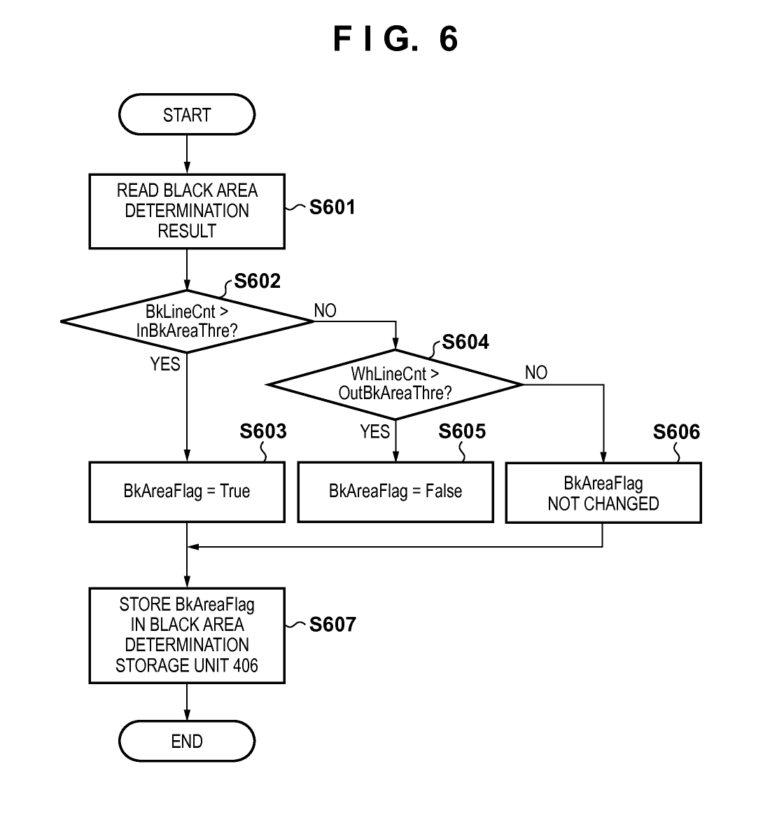

The black area determination unit 402 reads a number of consecutive black lines counted by the line width counter unit 401 from the line width count storage unit 405. Next, based on the number of consecutive black lines stored during processing of one line previous, it is determined whether or not those lines are currently within a black area, and the black area flag is changed in accordance with the determination result. Also, the determination result is written to the black area determination storage unit 406. The detailed processing of the black area determination unit 402 will be explained later using the flowchart of FIG. 6.

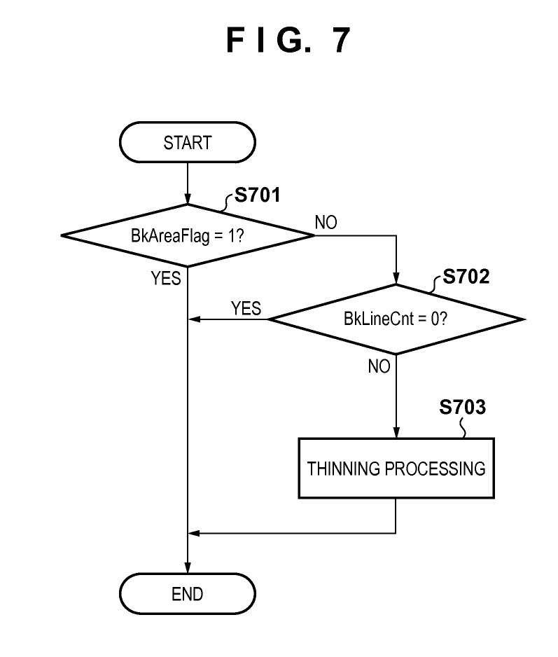

The thinning processing unit 403 performs thinning processing of image data received from the image processing unit 119 based on the black area flag and line width information acquired from the line width count storage unit 405 and the black area determination storage unit 406. Detailed processing of the thinning processing unit 403 will be explained later using the flowchart of FIG. 7.

The format conversion unit 404 converts image data on which thinning processing was performed by the thinning processing unit 403 into image data of a format that the printer unit 102 can print, and passes it to the printer unit 102.

FIG. 5 is a flowchart for describing an example of processing by a line width counter unit 401 according to the first embodiment. This flowchart is realized by the line width counter unit 401 in the first embodiment. Note, the CPU 112 may alternatively execute this based on a program stored in the ROM 113 having a similar function.

By this processing the line of interest is classified into either a black line, a white line or an “other”. Next, the following processing is performed to calculate consecutive count values of black and white lines, and a consecutive black line count value in the downstream area in the sub-scanning direction (hereinafter, BkLineCnt, WhLineCnt, BottomBkLineCnt).

Firstly, in step S501, the line width counter unit 401 reads in the sub-scanning direction upstream area (lines one-fifteen in the window) line count values for processing one line previous from the line width count storage unit 405. Next, these are made to be initial count values for BkLineCnt and WhLineCnt. Also, the initial value for BottomBkLineCnt is set to be “0”.

Next, the processing proceeds to step S502 and the line width counter unit 401 determines whether the line of interest is a black line, a white line or an “other” from the number of black pixels or a percentage of black pixels of the line of interest in the image data of the window (the sixteenth line in the window). For example, in a case where processing is done in nine pixel units (window width) at 600 dpi in the main scanning direction, it is determined that the line is a black line when the number of black pixels in the line of interest is nine, it is determined that the line is a white line when the number of black pixels is 0 and it is determined to be other when the number of black pixels is some other number of pixels.

In a case where the determination result is that the line is a black line in step S502, the processing proceeds to step S503, and the consecutive black lines count value (BkLineCnt) as well as the downstream area consecutive black line count value (BottomBkLineCnt) are incremented by 1. Also, because white lines are interrupted, it is determined that the consecutive white lines count value (WhLineCnt) is cleared to “0” and finalized.

Meanwhile, in a case where, in step S502, the line determination result is that the line is a white line, the processing proceeds to step S504, and the consecutive white lines count value (WhLineCnt) is incremented by 1. Also, because black lines are interrupted, the consecutive black lines count value (BkLineCnt) is cleared to “0” and finalized.

Also, when the determination result of step S502 is that the line is an “other”, the processing proceeds to step S505 and because both black and white lines are interrupted, both black and white lines count values (BkLineCnt, WhLineCnt) are cleared to “0” and finalized. Note, in a case where the counter value became a maximum value, that value is retained.

After step S503, step S504 or step S505 is executed, the processing proceeds to step S506 and the line width counter unit 401 writes each counter value to the line width count storage unit 405. These count values indicate counter values that count the number of consecutive black lines on the upstream side in the sub-scanning direction for the current line.

Next, the processing proceeds to step S507, and the line width counter unit 401 determines, for each line of the plurality of the downstream side (fifteen lines) of the line of interest in the window, whether the line is a black line, a white line or an “other” from the number of black pixels in the line or from the percentage of black pixels in the line. Next in a case where the determination result is that the line is a black line, the processing proceeds to step S508, and both BkLineCnt and BottomBkLineCnt are incremented by 1. Also, WhLineCnt is finalized and the corresponding count is stopped.

In a case where in step S507 the determination result is that the line is a white line, the processing proceeds to step S509, and WhLineCnt is incremented by 1. Also, BkLineCnt and BottomBkLineCnt are finalized and the corresponding counts are stopped. In a case where the determination result in step S507 is that the line is other, the processing proceeds to step S510, BkLineCnt, WhLineCnt and BottomBkLineCnt are finalized and the corresponding counts are stopped. After step S508, step S509 or step S510 is executed, the processing proceeds to step S511. Note, in step S508, step S509 and step S510, the value of a counter, once determined, is not updated even if it is determined that the next line in the window is a black line or a white line. In step S511, the line width counter unit 401 determines whether or not any downstream lines in the window remain (in other words, it determines whether or not processing of the fifteen lines is completed), and when it is determined that the processing has not yet completed, the processing proceeds to step S507, the previously described processing is executed, and processing completes.

Note, for the sake of simplicity of explanation, the thinning processing is controlled with two counters (BkLineCnt, BottomBkLineCnt), but a counter for lines that are other may also be maintained and used when performing the thinning processing. Also, after finalizing the counter values, increasing the corresponding count is no longer performed. Furthermore, initialization processing of the line counter is performed with the leading line of the image (not shown).

When the black line count value updating by the line width counter unit 401 completes, processing transitions to the black area determination unit 402.

As explained above, by the flowchart of FIG. 5, for each nine pixel×thirty one line window, a number of consecutive black lines, a number of consecutive white lines and a number of consecutive black downstream area lines, are acquired separately with counters, and stored. Then, when the window is moved towards the downstream side, and the line of interest is moved to the next line on the downstream side, the values of the aforementioned counters stored with the upstream lines are read in, and the count values of these counters are updated in accordance with the current line of interest. With this, it is possible to acquire the number of lines of consecutive black lines and white lines in the sub-scanning direction, and the number of black consecutive lines in the downstream area in image data, using a low memory capacity.

FIG. 6 is a flowchart for describing processing by the black area determination unit 402 according to the first embodiment. Processing shown in this flowchart is executed by the black area determination unit 402 in the first embodiment, but the CPU 112 may alternatively execute this based on a program stored in the ROM 113 having a similar function.

Firstly, in step S601, the black area determination unit 402 reads the black area determination value from processing for one line previous from the black area determination storage unit 406 and makes this the initial value of the black area determination value (hereinafter, BkAreaFlag). Next, the processing proceeds to step S602, and the black area determination unit 402 based on a number of consecutive black lines determines whether or not the current line is in a black area. In a case where the number of consecutive black lines is greater than a threshold (InBkAreaThre), the processing proceeds to step S603, it is determined that a black area has been entered, and the black area flag is set to be on (BkAreaFlag=True).

On the other hand, in a case where the number of consecutive black lines does not reach the threshold in step S602, the processing proceeds to step S604. In step S604, the black area determination unit 402 determines whether or not the black area has been exited based on the number of consecutive white lines. In a case where the number of consecutive white lines is larger than a threshold, the processing proceeds to step S605, it is determined that a white area has been entered, and the black area flag is turned off (BkAreaFlag=False). Meanwhile, in step S604, in a case where the number of consecutive white lines does not reach the threshold, the processing proceeds to step S606, and the black area flag is not changed.

After executing step S603, step S605 or step S606, the processing proceeds to step S607, and the black area determination unit 402 writes the black area determination value that was either updated or maintained in these steps to the black area determination storage unit 406. Note, the initialization processing of the black area flag is performed on the leading line of the image (not shown). When this updating of the black area flag completes, transition is made to the thinning processing unit 403.

As explained above, by the flowchart of FIG. 6, it can be determined, with low memory capacity, in image data, that there is a black area where the number of consecutive lines in the sub-scanning direction for black lines is greater than or equal to a predetermined value (threshold).

FIG. 7 is a flowchart for describing processing by the thinning processing unit 403 according to the first embodiment. Processing shown in this flowchart is executed by the thinning processing unit 403 in the first embodiment, but the CPU 112 may alternatively execute this based on a program stored in the ROM 113 having a similar function.

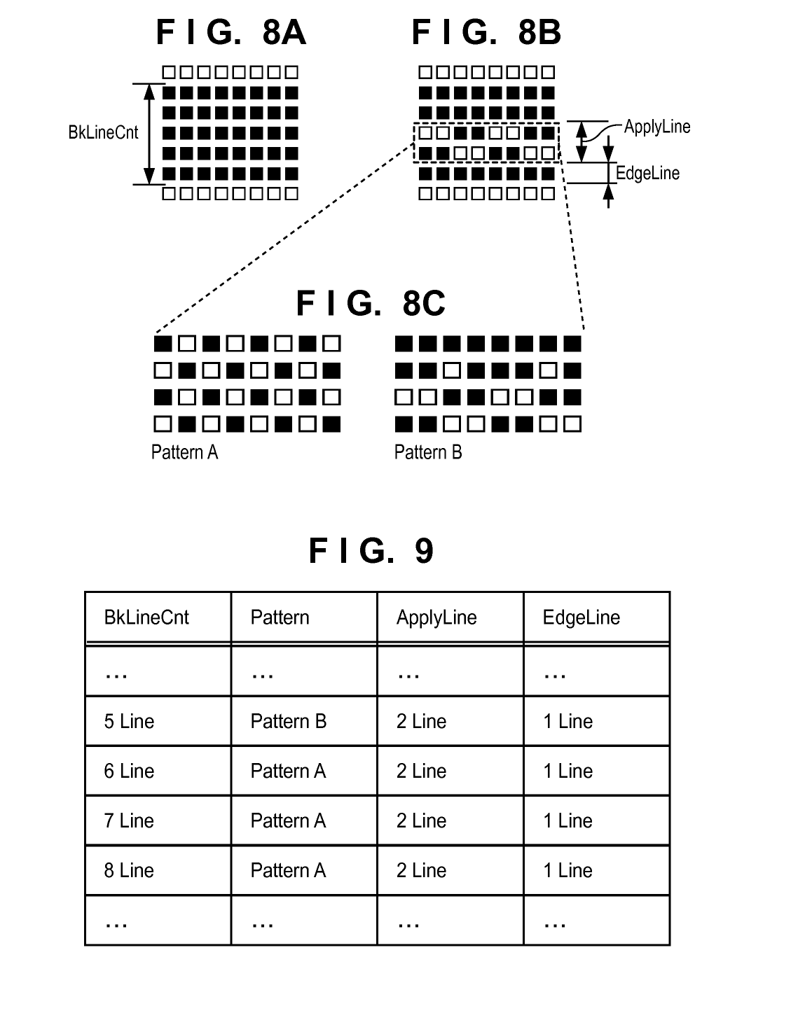

Firstly, in step S701 the thinning processing unit 403 determines whether or not the current pixel of interest is in a black area based on the black area flag (BkAreaFlag) determined by the black area determination unit 402. Here, in a case where it is determined that it is in a black area (BkAreaFlag=True), processing completes because it is not necessary to perform thinning. Meanwhile, in a case where, in step S701, it is determined that it is not in a black area, the processing proceeds to step S702. In step S702, the thinning processing unit 403 determines whether or not the line of interest that includes the pixel of interest is a black line, and in a case where it is not a black line (in other words BkLineCnt=0), it is determined that it is not necessary to apply thinning, and the processing completes. On the other hand, when, in step S702, the black lines (in other words the number of consecutive black lines (BkLineCnt) is not 0, the processing proceeds to step S703. In step S703, the thinning processing unit 403 performs thinning processing in accordance with the BkLineCnt value, the BottomBkLineCnt value and thinning setting information which will be explained later. This thinning processing will be explained in detail with reference to FIGS. 8A to 8C and with reference to FIG. 9.

FIG. 8A, FIG. 8B and FIG. 8C are views for explaining an outline of thinning processing by the thinning processing unit 403 according to the first embodiment.

FIG. 8A, FIG. 8B and FIG. 8C illustrate concrete examples of applying the thinning processing based on black line width information and previously retained thinning setting information (FIG. 9). Note, this thinning setting information is stored in the ROM 113 and embedded in program data as initialization setting information of the thinning processing unit 403.

FIG. 8A shows before the thinning processing, and FIG. 8B shows after the thinning processing. FIG. 8C shows thinning patterns. In this example, it is assumed that the thinning setting information is such that for a case where the consecutive black lines width is five lines (BkLineCnt=five lines), one line is left on the edge (EdgeLine=one line), and the thinning pattern is applied to two lines (ApplyLine=two lines). In other words, as in Equation 1 below, in a case where the BottomBkLineCnt value is larger than EdgeLine and smaller than or equal to (EdgeLine+ApplyLine), the thinning pattern is applied.

EdgeLine<BottomBkLineCnt<=(EdgeLine+ApplyLine) Equation 1

Also, it is assumed that the thinning pattern to be applied is pattern B (patternB) and so because ApplyLine is two lines, the downstream two lines of pattern B is used for the thinning processing. Here, thinning of the image data is executed by part of the image data included in the reference window being replaced with part of pattern B.

Note, the size of the pattern is not limited to the four×eight size of FIG. 8C, and it may be necessary to change the size in accordance with the resolution of the input and output image. Also, the black and white pattern registered in the pattern need not be a pattern having regularity. Also, a pattern may be used that suppresses the thinning amount the further away from the edge a line is.

FIG. 9 is a view for showing an example of the thinning setting information corresponding to black line widths for each black area state according to the first embodiment of the present invention.

In the example of FIG. 9, in a case where the consecutive black lines width is five lines (BkLineCnt=5), “pattern B” is used as the thinning pattern, and the number of lines to be applied (ApplyLine) is two lines. Also, the number of edge lines (EdgeLine) is set to be one line. This corresponds to FIG. 8A and FIG. 8B.

In this way, in the thinning processing of step S703, based on this setting information and counter information, it is possible to switch the thinning pattern, EdgeLine and ApplyLine and perform thinning processing.

Note, the thinning processing of step S703 according to the first embodiment determines thinning position and thinning amount based on the black line width after the black line width and the black area flag have been finalized. In other words, the thinning processing is applied on lines before the current line of interest. For that reason, the thinning processing unit 403 has a line buffer, and using the line buffer, the thinning processing unit 403 acquires image data of a line that is completely finalized, including with respect to thinning processing, and outputs the line data to the format conversion unit 404.

By the first embodiment, when calculating the number of consecutive black lines in the sub-scanning direction, for a count of the upstream area of the sub-scanning direction from the line of interest, calculation is performed using a result of one line previous stored in a storage unit. With this, the line buffer capacity for creating the window area can be reduced and the calculation amount can also be reduced.

For example, a reduction amount will be calculated for a case where the black area determination (black line/white line/other) is done in nine pixel×thirty one line window units at 600 dpi. In a case where the image size in the main scanning direction is thirteen inches, normally a 7800 pixel×30 line×1 bit line buffer is necessary. However, when the present embodiment is applied, in place of the line buffer of fifteen lines in the sub-scanning direction upstream area, all that is needed is a buffer for the counters for black and white lines (together a maximum of four bits) and a black area determination value (1 bit) for a sum total of 7800 pixels×2×(4+1) bits. In other words, a buffer capacity for 7800×20 bits can be reduced. In the following embodiments, only differences will be explained.

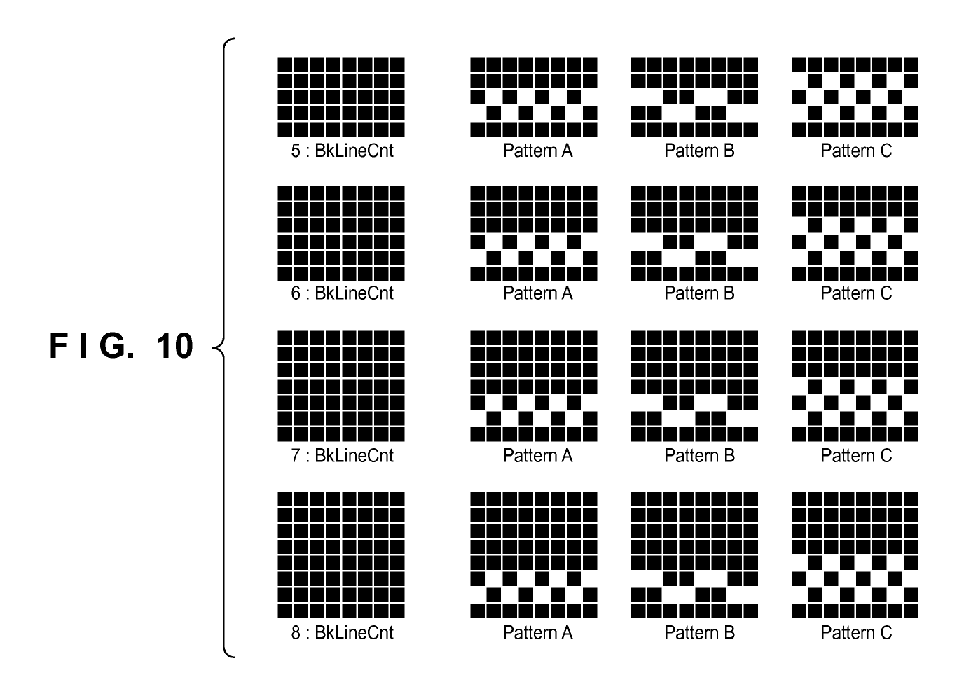

FIG. 10 is a view for showing examples of thinning patterns according to some embodiments, and shows examples in which in cases where consecutive black lines widths are of 5, 6, 7 and 8 lines, 2 line thinning patterns A and B, and a 3 line thinning pattern C are applied.

The thinning setting information shown in FIG. 9 defines which thinning pattern is applied for each consecutive black lines width. The thinning setting information is stored in the ROM 113 for example.

### Second Embodiment

In the second embodiment, explanation will be given for a case where a thinning processing method different from that used in the previously described first embodiment is used.

In the previously described first embodiment, the line widths are determined from the line counter values obtained from the line width counter unit 401, and thinning processing is performed by the thinning processing unit 403 in accordance with the line widths. In contrast to this, in the second embodiment, processing is performed for changing the sub-scanning direction upstream area line counter maximum value by changing the size of the reference window in accordance with apparatus characteristics.

The thinning characteristic is that the line width at which the tailing blur occurs differs according to the image forming speed of the image forming apparatus. Accordingly, when the size of the reference window changes, it is necessary to change the consecutive line number counter value. In other words, it is necessary to adjust the buffer memory capacity by increasing or decreasing the bit width of the count storage unit for the line width. For example, in a case where the speed of an engine is slow, the line width of the window may be shortened to be 16 lines.

In a case where processing is performed in hardware, processing is done at the maximum size, but in software, by making the size of the reference window to be optimal, the calculation amount is reduced, and it is possible to reduce the load on a processor of the CPU, for example.

### Third Embodiment

In the previously described first embodiment, the line width is determined from the line counter values obtained from the line width counter unit 401, and thinning processing is performed by the thinning processing unit 403 in accordance with the line width. In the third embodiment, processing for changing the upstream area line counter maximum value is performed by changing the reference window size in accordance with apparatus characteristics. The thinning characteristic is that the line width at which the tailing blur occurs differs in accordance with a resolution of the image forming apparatus. However, because the physical line width at which the tailing blur occurs does not change, for example, in a case where image data having a resolution of 1200 dpi is processed, the line width is twice what it is when the resolution is 600 dpi. For example, in a case where the resolution is 600 dpi, the window size is made to be 16 lines, and when it is 1200 dpi, the window size is made to be 32 lines. In this way, the window size changes and the consecutive line number counter value changes. In other words, the buffer memory capacity is adjusted by increasing or decreasing the bit width of the line width count storage unit 405.

In a case where processing is performed in hardware, processing is done at the maximum size, but in software, by making the size of the reference window to be optimal, the calculation amount is reduced, and it is possible to reduce the load on a processor of the CPU, for example.

### Fourth Embodiment

In the previously described first embodiment, the line width is determined from a line counter value obtained from the line width counter unit 401, and thinning processing is performed by the thinning processing unit 403 in accordance with the line width. In contrast to this, in the fourth embodiment, processing is performed for changing the sub-scanning direction upstream area line counter maximum value by changing the size of the reference window in accordance with apparatus characteristics. The thinning characteristic is that the line width at which the tailing blur occurs differs in accordance with a humidity level of the surrounding environment of the image forming apparatus. Accordingly, it is determined how easily the tailing blur can occur by estimating an amount of moisture contained from a humidity level and temperature, and, for example, use a larger line width in a case of high temperature and humidity (for example 16 lines) and use a smaller line width in a case of low temperature and dryness (for example, 4 lines). In this way, when the size of the reference window changes, it is necessary to change the consecutive line number counter value. In other words, the buffer memory capacity is adjusted by increasing or decreasing the bit width of the line width count storage unit 405.

In a case where processing is performed in hardware, processing is done at the maximum size, but in software, by making the size of the reference window to be optimal, the calculation amount is reduced, and it is possible to reduce the load on a processor of the CPU, for example.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-250586, filed Nov. 14, 2012, which is hereby incorporated by reference herein in its entirety.

1. An image processing apparatus comprising:
a first determination unit configured to determine whether or not a line of interest is a black line;
a counting unit configured to count, when the first determination unit determines that the line of interest is the black line, a number of consecutive black lines;
a second determination unit configured to determine whether or not the line of interest is in a black area in accordance with whether or not the number of consecutive black lines counted by the counting unit is greater than a predetermined value; and
an image processing unit configured to, in a case that the first determination unit determines that the line of interest is the black line and the second determination unit determines that the line of interest is not in the black area, execute thinning processing for the line of interest.

2. The image processing apparatus according to claim 1, wherein the image processing unit executes the thinning processing in accordance with thinning processing setting information.

3. The image processing apparatus according to claim 2, wherein the thinning processing setting information includes information for specifying a pattern, which is associated with the number of consecutive black lines, to be used in the thinning processing, and
the image processing unit is further configured to replace, when the line of interest is not in the black area, a part of image data with the pattern.

4. The image processing apparatus according to claim 1, wherein the first determination unit is configured to determine, in a case where a number of black pixels included in the line of interest is greater than or equal to a predetermined value, that the line of interest is the black line.

5. The image processing apparatus according to claim 1, wherein a direction of the line of interest is a main scanning direction and the number of consecutive black lines is a number of consecutive black lines in a sub-scanning direction.

6. The image processing apparatus according to claim 1, further comprising:
an outputting unit configured to output, to an image forming apparatus, image data for which the thinning processing has been executed by the image processing unit.

7. The image processing apparatus according to claim 1,
wherein a size of a window including the line of interest is changed in accordance with a resolution of image data, an image forming speed of the image forming apparatus or a surrounding environment of the image forming apparatus.

8. The image processing apparatus according to claim 1, further comprising:
a retention unit configured to retain, in association with the line of interest, a determination result made by the second determination unit and the number of consecutive black lines acquired by the counting unit,
wherein the image processing unit executes the thinning processing for the line of interest, based on the determination result and the number of consecutive black lines retained by the retention unit.

9. An image processing method for controlling an image processing apparatus, the method comprising:
determining whether or not a line of interest is a black line;
counting, when in the determining it is determined that the line of interest is the black line, a number of consecutive black lines;
determining whether or not the line of interest is in a black area in accordance with whether or not the number of consecutive black lines counted in the counting is greater than a predetermined value; and
in a case that it is determined that the line of interest is the black line and it is determined that the line of interest is not in the black area, executing thinning processing for the line of interest.

10. A non-transitory computer-readable storage medium storing a program for causing a computer to function as the image processing apparatus, wherein the image processing apparatus comprises:
a first determination unit configured to determine whether or not a line of interest is a black line;
a counting unit configured to count, when the first determination unit determines that the line of interest is the black line, a number of consecutive black lines;
a second determination unit configured to determine whether or not the line of interest is in a black area in accordance with whether or not the number of consecutive black lines counted by the counting unit is greater than a predetermined value; and
an image processing unit configured to, in a case that the first determination unit determines that the line of interest is the black line and the second determination unit determines that the line of interest is not in the black area, execute thinning processing for the line of interest.
